(19) United States
(12) Patent Application Publication
(10) Pub. No.: US 2026/0000100 A1
(43) Pub. Date: Jan. 1, 2026

(54) PLANT-ONLY CHEESE FLAVORING REPLACEMENT SYSTEM IN FOOD PRODUCTS

(71) Applicant: The Live Green Group, Inc.,, Middletown, DE (US)

(72) Inventors: Sasikanth Chemalamudi, San Fernando (CL); Priyanka Srinivas, San Fernando (CL)

(21) Appl. No.: 18/879,275

(22) PCT Filed: Aug. 19, 2023
(86) PCT No.: PCT/IB2023/058302

§ 371 Date: Dec. 27, 2024

Related U.S. Application Data
(60) Provisional application No. 63/399,366, filed on Aug. 19, 2022.

(51) Int. Cl. A23L 27/12; A23L 27/16

(52) U.S. Cl. CPC A23L 27/12; A23L 27/16

(57) ABSTRACT

A plant-only cheese flavoring replacement system in food products is provided. The plant-only cheese flavoring replacement system in food products is prepared by mixing a) 10-35% by weight of a fruit source, b) 10-40% by weight of a vegetable source, and c) 5-25% by weight of herbs and spices source. This plant-only cheese flavoring replacement system in food products can be effectively added to snacks like crackers, chips, and popcorn, dairy products such as cream cheese, sour cream, and yogurt to create cheese-based dips and spreads.

### CROSS-REFERENCE TO RELATED APPLICATIONS

This application claims priority to the U.S. provisional patent application No. 63/399,366, filed on Aug. 19, 2022 and PCT provisional patent application no.: PCT/IB2023/058302, filed on Aug. 19, 2023, titled “PLANT-ONLY CHEESE FLAVORING REPLACEMENT SYSTEM IN FOOD PRODUCTS” and is incorporated herein by reference.

### TECHNICAL FIELD

The disclosed embodiment relates to plant-only cheese flavoring replacement system. More particularly, for chemical, synthetic and/or highly processed flavoring ingredients added to commercial food products.

### BACKGROUND OF THE DISCLOSED EMBODIMENT

Many commercially available, processed plant-based and animal-based food products contain natural and synthetic food additives such as artificial flavors and other highly processed ingredients. The categories of commercially available food products containing such additives vary greatly, and include both savory and sweet baked and fried food products, snack products, a variety of frozen foods, vegetables and vegetable-containing foods, as well as animal flesh-based food products (i.e., those containing any one or more of beef, pork, poultry, fish, shellfish and other seafood and other products), and imitation meat/seafood-containing products in various forms based whole or in part on plant-derived materials, or food products composed of a combination both animal-sourced and plant-sourced materials.

Commercially available food products (include flavorings) are often highly processed and may contain meat or seafood flesh or other animal-sourced products in addition to added saturated fats, highly processed ingredients, synthetic additives and/or other ingredients that may be inappropriate for certain diets, e.g., vegetarian, vegan, salt-restricted, low-fat, low saturated fat, culturally or religiously-restricted diets, etc. Even some commercially available “plant-based,” “plant-derived,” food products (depending on how those terms are defined by the manufacturers, or under definitions supported by a governmental authority in the location of manufacture) may contain animal-derived ingredients, which can render even “plant-based” products inappropriate for vegetarians and vegans. We distinguish “plant-based” products (which may include ingredients sourced from animals) from the “plant-only” meat-or seafood-analogue (imitation) food products, or other food products that may feature a cheese flavoring. These terms are discussed in more detail and the categories distinguished further below.

Some flavoring agents have been developed to mimic the qualities that consumers of plant-based alternatives desire in a food product flavoring without altering the product's texture, behavior at different temperatures, and stability over time. Examples of food additives commonly found in commercially available flavorings used in other food products are modified starches, monosodium glutamate (MSG), calcium chloride, cheese salt, liquid smoke, edible ash, agar agar (the latter, a gelatin substitute), and maltodextrin. Many such additives (particularly synthetic additives) could pose a harm to consumers, especially those with food sensitivities or allergies, or if consumed over prolonged periods. The food industry uses more than 7,000 synthetic and ultra-processed additives even though nature offers more than ten million compounds from more than 450,000 plants.

It would be desirable to provide solely plant-or fungi-derived, or other natural source-derived ingredients that are not from the animal kingdom (hereafter, “plant-only”) that replace highly processed, synthetic, artificial and/or animal-derived (i.e., sourced directly or indirectly from an animal), commercially available flavoring agents. A “plant-only” food product is free from dairy and other animal-derived ingredients and is minimally processed, with—or, as a component of another food product, contributing to—a desirable flavor, taste, texture, homogeneity, consistency, color and appearance so as to be aesthetically pleasing to consumers.

Therefore, there is a need to develop of plant-only cheese flavoring replacement system in food products.

### Summary of the Disclosed Embodiment

An aspect of the disclosed embodiment of plant-only cheese flavoring replacement system in food products.

According to the aspect of disclosed embodiment, the plant-only cheese flavoring replacement system for use in food products comprising: a) 10-35% by weight of a fruit source, b) 10-40% by weight of a vegetable source, and c) 5-25% by weight of herbs and spices source.

According to an embodiment, the plant-only cheese flavoring replacement system for use in food products, wherein the fruit source is selected from blueberries, strawberries, apricots, cherry tomatoes, Pineapple, Tamarillo, Plum, Barbados cherry, Pomelo, Peach or combinations thereof.

According to another embodiment, the plant-only cheese flavoring replacement system for use in food products, wherein the vegetable source is selected from bell peppers, Cabbage, Onions, Garlic, Green beans, Broccoli, Cauliflower, Celery, Asparagus, sweet potatoes or combinations thereof.

According to one embodiment, the plant-only cheese flavoring replacement system for use in food products, wherein the herbs and spices source is selected from ginger root, turmeric root, black peppers, rosemary, Peppermint, coriander leaves, thyme, M. spicata, Angelica, Caper, Sweet Marjoram or combinations thereof.

According to one more embodiments, the plant-only cheese flavoring replacement system for use in food products, wherein the food products comprise crackers, chips, popcorn, dairy products comprising cream cheese, sour cream, and yogurt to create cheese-based dips and spreads, baked goods comprising bread, muffins and biscuits, meat analogues, salads and dressings comprising Alfredo sauce and Caesar dressing, beverages comprising smoothies and protein shakes to create a savory, cheesy flavor profile.

According to the aspect of disclosed embodiment, a method for preparing a plant-only cheese flavoring replacement system for use in food products, wherein the method comprises: mixing a) 10-35% by weight of a fruit source, b) 10-40% by weight of a vegetable source, and c) 5-25% by weight of herbs and spices source at a temperature between 60 degrees Celsius and 105 degrees Celsius for about 30 seconds to one minute to form the plant-only cheese flavoring replacement system.

According to an embodiment, a method wherein the fruit source is selected from blueberries, strawberries, apricots, cherry tomatoes, Pineapple, Tamarillo, Plum, Barbados cherry, Pomelo, Peach or combinations thereof.

According to another embodiment, a method wherein the vegetable source is selected from bell peppers, Cabbage, Onions, Garlic, Green beans, Broccoli, Cauliflower, Celery, Asparagus, sweet potatoes or combinations thereof.

According to one embodiment, a method wherein the herbs and spices source is selected from ginger root, turmeric root, black peppers, rosemary, Peppermint, coriander leaves, thyme, M. spicata, Angelica, Caper, Sweet Marjoram or combinations thereof.

According to one more embodiments, a method wherein the food products comprise crackers, chips, popcorn, dairy products comprising cream cheese, sour cream and yogurt to create cheese-based dips and spreads, baked goods comprising bread, muffins and biscuits, meat analogues, salads and dressings comprising Alfredo sauce and Caesar dressing, beverages comprising smoothies and protein shakes to create a savory, cheesy flavor profile.

According to yet another embodiment, a method wherein physical characterization data associated with ingredients of the plant-only cheese flavoring replacement system comprising the fruit source, the vegetable source, the herbs and spice source is stored in a database, wherein a machine learning model determines a unique combination of ingredients based on the physical characterization data to prepare the plant-only cheese flavoring replacement system.

According to further embodiment, a method wherein the physical characterization data of the ingredients comprise functional properties that comprise emulsification properties, stabilization properties, gelling properties, fat-replacement properties, Ayurvedic and/or other holistic properties, physicochemical properties that comprise pH, viscosity, moisture content, density, mechanical properties that comprise adhesive strength, tensile strength, shear resistance, chemical and/or molecular descriptor properties that comprise bio-active/bioavailability properties, molecular structure, phytonutrient properties, sensorial properties that comprise taste, smell, color, texture, mouth feel, and nutritional information that comprises macronutrient/micronutrient properties.

Several aspects of the invention are described below with reference to examples for illustration. However, one skilled in the relevant art will recognize that the invention can be practiced without one or more of the specific details or with other methods, components, materials and so forth. In other instances, well-known structures, materials, or operations are not shown in detail to avoid obscuring the features of the invention. Furthermore, the features/aspects described can be practiced in various combinations, though only some of the combinations are described herein for conciseness.

### BRIEF DESCRIPTION OF THE DRAWINGS

The foregoing and other objects and features of the disclosed embodiment will become more fully apparent from the following description and appended claims, taken in conjunction with the accompanying drawings. Understanding that these drawings depict only typical embodiments of the disclosed embodiment and are, therefore, not to be considered limiting of its scope, the disclosed embodiment will be described with additional specificity and detail through use of the accompanying drawings briefly described below:

FIG. 1 is a flowchart that illustrates the method involved in preparation of plant-only cheese flavoring replacement system in food product, according to the aspect of the disclosed embodiment.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE DISCLOSURE

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another. Further, the terms “comprising,” “including,” “having,” and the like, as used with respect to embodiments of the present disclosure, are synonymous. As used herein, the terms “agent,” “component,” or “ingredient” are used interchangeably and refer to a particular item that includes one or more chemical compounds (e.g., a food item from one or more plants that comprise one or more naturally occurring chemical compounds).

The term “component” or “ingredient” as used herein, refers to a particular item that includes one or more chemical compounds, i.e., edible compounds sourced from plants, fungi or algae that comprise one or more naturally occurring chemical compounds.

Alternative embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

As used herein, the singular forms “a”, “an”, and “the” include both singular and plural referents unless the context clearly dictates otherwise. By way of example, “a dosage” refers to one or more than one dosage.

The terms “comprising”, “comprises” and “comprised of” as used herein are synonymous with “including”, “includes” or “containing”, “contains”, and are inclusive or open-ended and do not exclude additional, non-recited members, elements or method steps.

All documents cited in the present specification are hereby incorporated by reference in their totality. In particular, the teachings of all documents herein specifically referred to are incorporated by reference.

Example embodiments of the disclosed embodiments are described with reference to the accompanying figures.

In the drawings, like reference numbers generally indicate identical, functionally similar, and/or structurally similar elements. The drawing in which an element first appears is indicated by the leftmost digit(s) in the corresponding reference number.

### Definitions

The term “Cheese flavoring” refers to a type of food additive or seasoning that is designed to impart the taste and aroma of cheese to various food products. It is used to enhance the cheese flavor in snacks, sauces, dips, and other food items, without the need for actual cheese or as a supplement to natural cheese. Cheese flavoring can come in various forms such as powdered cheese, liquid cheese, or cheese-flavored seasonings.

The term “Starch” refers to a polymeric carbohydrate consisting of numerous glucose units.

The term “Blender” refers to an appliance used to mix, crush, purée or emulsify food and other substances.

The term “FDA” refers to Food and Drug Administration

The term “Machine learning model” refers to computer software designed to recognize patterns or behaviors based on previous experience or data.

The term “Plant-based” refers to largely or solely of vegetables, grains, pulses, or other foods derived from plants, rather than animal products.

The term “Frozen” refers to liquid form turned into ice as a result of extreme cold.

The term “Plant-derived” refers to ingredients extracted from a plant.

The term “Plant-only” products disclosed herein, as opposed to products labeled as “plant-based,” and the like, refer to food products whose ingredients, apart from any significant amount of water added, are derived solely from sources outside of the animal kingdom, e.g., from plants, fungi, or algae. That is, “plant-only” may refer to any composition, formulation, system or the entire food product, that is produced, developed, or otherwise obtained directly or indirectly from one or more plants, fungi, or algae, is not synthetic, and is only minimally processed for production, e.g., cleaned, dried, pulverized, etc.

The term “food product” refers broadly to any edible food or product, raw or cooked, savory or sweet, whether intended for human or animal consumption; a food product may be edible although not intended to be consumed on its own but, rather, incorporated into a second (or third) food product that is considered a consumable.

The cheese flavor replacement system is not intended to be consumed as is. Rather, the system is preferably mixed with other ingredients and possibly other plant-only replacement systems disclosed elsewhere in a food product, which, it may be, incorporated into other food products. The consumable food products may be plant-only food products, plant-based food products, or even animal flesh-based food products.

The Applicant, Live Green Company, is the market maker of the Plant-only category, which means that all the animal, synthetic and ultra-processed ingredients are replaced by plant-derived ingredients with superior nutritional profiles without impacting the original organoleptic properties.

Embodiments disclosed herein for a plant-only cheese flavoring replacement system to be used in place of commercially available, synthetic or processed flavorings, flavoring mixes, and other additives to be used in or on (as a seasoning) a variety of food products, including baked and fried food products, snack products, vegetables and vegetable-containing food products, animal-based (meat/seafood) and plant-derived imitation meat or seafood food products. The plant-only ingredients and combinations of ingredients selected by the machine learning system, discussed briefly below and disclosed elsewhere, provide effective organoleptic features that replace, and provide a natural cheese flavor for those synthetic or processed ingredients found in commercially available flavoring agents.

Commercially available flavorings used in meat-or seafood-based food products and imitation meat/sea food-based food products such as highly processed plant-based or plant-derived, imitation animal flesh-alternatives are one category of food products that can benefit from replacement of commercially available, traditionally used, synthetic or processed additives. The plant-only ingredients and additives in the disclosed embodiments of the cheese flavoring replacement system provide a natural cheese flavor without including any animal-derived products. In the disclosed embodiments, plant-only ingredients effectively function as flavoring agents in food products, replacing the conventional, non-plant-derived, synthetic or highly processed additives and ingredients normally found in commercially available food products. In the disclosed embodiments, plant-only food additive replacements (or replacement systems) are comprised of only minimally processed, naturally occurring (i.e., non-synthetic) ingredients sourced solely from plants, fungi and algae, i.e., they are not sourced from the animal kingdom.

Although it may be available commercially as a stand-alone food product, in most embodiments the cheese flavoring replacement system is not intended to be consumed as a stand-alone (“consumable”) food product. Rather, the system is preferably mixed with other ingredients or food products, and possibly other plant-only replacement systems disclosed elsewhere. This food product itself also may be incorporated into one or more other consumable food products. In other embodiments the cheese flavoring replacement system may be used as a seasoning coating in a powder-like consistency on a consumable food product. In still other embodiments, the replacement system may be used as a seasoning coating with a liquid or cream-like consistency. In other embodiments the replacement system may be mixed into a food product and also used as a coating with a powder, liquid, or cream consistency. In disclosed embodiments, the consumable food products in which the replacement system is used in or on include may be, among other types mentioned above, plant-only food products (e.g., breads, pasta, vegetables or imitation meat or seafood products), plant-based food products, or even animal flesh-based food products.

Other embodiments disclosed include the plant-only cheese flavoring replacement system, or components of it, for replacing one or more processed or synthetic ingredients, i.e., flavoring agents or their combinations traditionally found in commercially available food products. In some embodiments the cheese flavoring replacement system is a stand-alone food product that may be consumed as a seasoning on or incorporated into other food products. In certain embodiments the cheese flavoring replacement system is a component in the meat-based or imitation meat-based food products; in other embodiments, the cheese flavoring replacement system is a component of seafood or imitation seafood food products. In other embodiments, the cheese flavoring replacement system is used to enhance the nutritional or aesthetic value of the food product. In other embodiments the cheese flavoring replacement system's plant-only ingredients may replace any-even partially-animal-derived ingredients of so-called “plant-derived,” plant-based,” or “meatless” food product, including food product mixes.

“Plant-only” products disclosed herein, as opposed to products labeled as “plant-derived,” “plant-based,” and the like, refer to food products whose ingredients, apart from any significant amount of water added, are derived solely from sources outside of the animal kingdom, e.g., from plants, fungi, or algae. That is, “plant-only” may refer to any agent, ingredient, or component of a food product, or the entire food product itself, that is produced, developed, or otherwise obtained directly or indirectly from one or more plants, fungi, or algae, is not synthetic, and is only minimally processed for production, e.g., cleaned, dried, pulverized, etc.

While some manufacturers may refrain from including any ingredients sourced from animals in their “plant-based” (and other similarly labeled) products, the term “plant-based” may also encompass ingredients and food products that may be obtained from animals. The US Food and Drug Administration currently has no accepted standard definition for labeling of food products described as “plant-based” or “plant-derived,” although a private trade organization, the Plant Based Food Association, has proposed voluntary standards to ensure consistency when the term “plant-based” is used on a product label (i.e., it contains no animal-sourced content), and seeks to certify-through its own certification process-food products, including food product mixes, that meet this standard See https://www.plantbasedfoods.org/policy/labeling/. The terminology used on a label for a plant-based food must be truthful under FDA regulations; however, in the US, no regulatory body currently requires a company to refrain from including some amount of meat, seafood, or other animal-sourced ingredients in a “plant-based” product.

The term “food product” refers broadly to any edible good or product, raw or cooked, savory or sweet, whether intended for human or animal consumption; a food product may be edible although not intended to be consumed on its own but, rather, incorporated into a second (or third) food product that is considered a consumable. The cheese flavoring replacement system disclosed herein in certain embodiments may be incorporated into or used with meat-based food products; in other embodiments it may be incorporated into or used with seafood-based food products; in still other embodiments, it may be incorporated into or used with plant-based food products. In certain preferred embodiments, the cheese flavoring replacement system may be incorporated into or used with plant-only food products, including breads and other baked and fried foods.

In certain embodiments, while some of the water content of a food product may be derived from a plant source, water may also be added to the product from an external source. For example, in scenarios in which a plant only agent or system or plant only food product is in the form of a gel or liquid, it is further understood that water can be included as solvent or liquid carrier for the plant-only system, ingredient or food product, where any amount of water (some or all) within the system, ingredient or food product may or may not be derived from a plant source. In some embodiments, water may be added from an external source as part of the plant-only cheese flavoring replacement system (or any other plant-only replacement system referenced herein). In other embodiments the plant only flavoring replacement system may be available in a dried form; in certain embodiments the dried form may be powdered; in other embodiments, the dried form of the flavoring replacement system may be in a partially powdered form; in other embodiments it may be available in a semi-liquid or gel form; in other embodiments it may be in a liquid or frozen form.

In the disclosed embodiments, apart from externally-sourced water, the plant-derived food product consists entirely of ingredients derived from plants, fungi or algae, excluding any component or ingredient that is: (i) dairy-based or otherwise derived from any member of the animal kingdom; and (ii) more than minimally processed; and (ii) synthetic.

### 1. EMBODIMENTS OF THE DISCLOSURE

The disclosed embodiment is in the technical field of plant only cheese flavoring replacement system in food products.

In an embodiment, the term “Cheese flavoring” refers to a type of food additive or seasoning that is designed to impart the taste and aroma of cheese to various food products. It is used to enhance the cheese flavor in snacks, sauces, dips, and other food items, without the need for actual cheese or as a supplement to natural cheese. Cheese flavoring can come in various forms such as powdered cheese, liquid cheese, or cheese-flavored seasonings.

### 2. FUNCTIONALITY AND PARAMETERS

TABLE 1
Parameter ranges associated with ingredients of the plant-
only cheese flavoring replacement system in food products

| Categories | Parameters and ranges | | | |
|---|---|---|---|---|
| Fruit | Primary bioactive | Balance of non-volatile | Flavor | |
| source(s): | compounds | and volatile | Aromatics: | |
| | responsible for | constituents that | Fruity | |
| | cheese flavor: | contribute to taste and | notes, | |
| | Sulfur-containing | aroma: | Pungency, | |
| | compounds such as | Sweetness: fructose | milk/dairy | |
| | methional, esters, | (1.2) > sucrose (1.0) > | like flavor | |
| | glutamate, lactones | glucose (0.64). | aromatics | |
| | like decalactones, | Sourness or acidity is | | |
| | linalool, cis-3- | determined by the | | |
| | hexenol and | concentrations of the | | |
| | related | predominant organic | | |
| | compounds. | acids, which are ranked | | |
| | | relative to citric acid in | | |
| | | the following order of | | |
| | | sourness: citric (1.0) > | | |
| | | malic (0.9) > tartaric | | |
| | | (0.8); | | |
| | | Some amino acids, such | | |
| | | as aspartic and glutamic, | | |
| | | may also contribute to | | |
| | | sourness. | | |
| Vegetable | Primary bioactive | TAV (Threshold | Flavor | |
| source(s): | compounds | Aroma Value): | Aromatics: | |
| | responsible for | minimum concentration | earth/bell | |
| | cheese flavor: | of a volatile organic | pepper | |
| | Volatile sulfur | compound required to | (EBP) | |
| | compounds like | detect a specific aroma | flavors, | |
| | Dimethyl | or flavor note. The TAV | umami and | |
| | trisulfide, hexanal, | values of dimethyl | spice flavor | |
| | alkyl pyrazines and | trisulfide, hexanal, and | notes and | |
| | related | alkyl pyrazines can vary | rich after | |
| | compounds. | depending on the | notes | |
| | | specific compound and | | |
| | | the source of the | | |
| | | vegetable. | | |
| | | Garlic: dimethyl | | |
| | | trisulfide in garlic is | | |
| | | estimated to be around | | |
| | | 0.01 ppm. | | |
| | | Onions: dimethyl | | |
| | | trisulfide in onions is | | |
| | | estimated to be around | | |
| | | 0.02 ppm. | | |
| | | Broccoli: hexanal - 0.02 | | |
| | | ppm. | | |
| | | Green beans: alkyl | | |
| | | pyrazines in green beans | | |
| | | is estimated to be around | | |
| | | 0.005 ppm. | | |
| Herbs and | Primary bioactive | Content of major | Flavor | Effect of |
| spices | compounds | flavor amino | Aromatics: | Umami |
| source(s): | responsible for | acids/compounds by | peppery | components |
| | cheese flavor: | HPLC profile in | and sweet, | (EUC (g |
| | Glutamic acid, | percentage: | with a | MSG/100 |
| | P-cresol and | Ginger root: | pungent | g) |
| | Limonene (4- | Aspartic Acid: 29.80% | and spicy | 3-83% |
| | Methyl phenol), | Glutamic Acid: 35.8% | aroma and | |
| | glutamic acid, | Rosemary: | umami | |
| | aspartic acid, | Aspartic acid: 4.77 to | taste | |
| | proline and other | 15.75% | | |
| | related | Coriander leaves: | | |
| | compounds. | 1-Decanol: 20% | | |
| | | Peppermint: | | |
| | | Menthol: 46% | | |
| | | M. spicata: | | |
| | | Limonene: 37% | | |

In an embodiment, the selection of a specific combination of ingredients for plant-only products was determined using a proprietary machine learning (ML) tool, which blends ancestral wisdoms of plant nutrition with biotechnology and ML to analyze members of, primarily, the plant and fungi kingdoms, as well as other potential, natural, sources outside of the animal kingdom for the compounds nature offers.

In another embodiment, the platform utilizes algorithms and includes a database with a significant number of ingredients (e.g., 50,000-100,000 ingredients) and relevant physical properties associated with such ingredients.

In one embodiment, for example, physical characterization data and information about each ingredient for some or all of the ingredients in the database include, without limitation, functional properties (e.g., emulsification properties, stabilization properties, bulking properties, texturizing properties, gelling properties, fat-replacement properties, etc.) and aesthetic properties relating to flavorings.

In one more embodiment, ayurvedic and/or other holistic properties, physicochemical properties (e.g. pH, viscosity, moisture content, density, etc.), mechanical properties (e.g. adhesive strength, tensile strength, shear resistance, etc.), chemical and/or molecular descriptor properties (e.g., bio-active/bioavailability properties, molecular structure, phytonutrient properties, etc.), sensorial properties (e.g., taste, smell, color, texture, mouth feel, etc.), and nutritional information (e.g., macronutrient/micronutrient properties, etc.) are also considered in the proprietary system to give optimal results in terms of functionality, health and sustainability.

In yet another embodiment, based upon the known properties of ingredients in the database, the desired properties for the food product or formulation, and one or more algorithms associated with the proprietary machine learning platform, a unique combination of plant-only ingredients was determined to yield an effective flavoring replacement formulation that can be used to create a desirable food product or formulation that is effective as a substitute for conventional ingredients in food products of all kinds.

In yet another embodiment, as noted, the proprietary system identifies natural alternatives, i.e., as defined, “plant-only” alternatives to synthetic, artificial, and animal-derived products, and incorporates in its algorithms, among other things, traditional knowledge known as ayurvedic medicine.

In further embodiment, ayurvedic medicine and its diet principles have been practiced for many thousands of years. This ancient system, among other things, categorizes food by its medicinal properties and desired effects; thus, the proper application of ayurvedic principles requires knowledge of the self-one's dominant energy, also known as dosha-to prescribe the most advantageous categories of foods from which to choose for an individual's diet.

In further embodiment, categories of ayurvedic properties include but are not limited to Virya (hima/sheeta-cold), Vipaka (Madhura-sweet), Rasa (Madhura-sweet), and Guna (ruksha-dry; or guru-heavy). The information recommended by the proprietary Machine learning system permits one to choose among hundreds of alternatives based on ingredients intended to alter a variety of properties to give optimal results for aesthetic purposes (i.e., flavorings, mouth feel, etc.) as well as physiological functionality, health, and environmental sustainability.

In an exemplary embodiment, A food product flavoring replacement system as described herein functions to replace synthetic or artificial additives and flavorings and comprises a combination of plant-or fungi-, or algae-sourced ingredients and added water, if any is required for their preparation. The plant-only ingredients and combinations of ingredients selected for the flavoring replacement system are consistent with the requirements and specifications of achieving the sensory features exhibited by conventional flavoring agents.

### 3. PLANT-ONLY CHEESE FLAVOR REPLACEMENT SYSTEM

In an embodiment, the term “Cheese flavoring” refers to a type of food additive or seasoning that is designed to impart the taste and aroma of cheese to various food products. It is used to enhance the cheese flavor in snacks, sauces, dips, and other food items, without the need for actual cheese or as a supplement to natural cheese. Cheese flavoring can come in various forms such as powdered cheese, liquid cheese, or cheese-flavored seasonings.

### 4. EXAMPLE EMBODIMENTS

The disclosed embodiment will be further described in the following examples. It should be understood that these examples are for illustrative purposes only and are not to be construed as limiting this disclosed embodiment in any manner.

TABLE 2
Preferred, Essential Plant-Only Cheese Flavoring
Replacement System Categories/Ingredients

| | | Preferred Weight |
|---|---|---|
| Preferred, Essential Plant-Only | | Percent of the |
| Cheese Flavoring Replacement | Additional | Replacement |
| System Categories/Ingredients | ingredients | System |
| 1. Fruit source(s): any one or more of | Pineapple, Tamarillo, | 10-35 |
| blueberries, strawberries, apricots, | Plum, Barbados | |
| cherry tomatoes and/or any substitutes | cherry, Pomelo, Peach | |
| imparting the same or similar flavors, | | |
| properties and/or functionalities | | |
| 2. Vegetable source(s): bell peppers | Cabbage, Onions, | 10-40 |
| and/or any substitutes imparting the | Garlic, Green beans, | |
| same or similar flavors, properties | Broccoli, Cauliflower, | |
| and/or functionalities | Celery, Asparagus, | |
| | sweet potatoes | |
| 3. Herbs and spices source(s): any | Peppermint, coriander | 5-25 |
| one or more of ginger root, turmeric | leaves, thyme, M. | |
| root, black peppers, rosemary and/or | spicata, Angelica, | |
| any substitutes imparting the same or | Caper, Sweet | |
| similar flavors, properties and/or | Marjoram | |
| functionalities | | |

In some embodiments, within each of the three categories in Table 2, one of the listed ingredients (or one or more plant-only alternatives to that ingredient, which alternatives impart the same or similar flavor as the replaced ingredient) may be used as the cheese flavoring replacement system. In other embodiments, two or more listed ingredients (or their plant-only alternatives, as above) may be combined in varying amounts for the replacement system. In certain embodiments one or more representative ingredients from each of the three categories are mixed to form the replacement system. In still other alternative embodiments, any of the ingredients listed in Table 2 may be replaced by one or more plant-only substitute ingredients (not listed) that impart the same or similar flavors and/or properties and functionalities to the food product as the ingredient(s) being replaced.

Although Table 2 provides a preferred, essential list of categories of ingredients imparting particular a variety of flavorings in the cheese flavoring replacement system, substitutions for these ingredients in the replacement system may be made in alternative embodiments for compliance with dietary requirements, without limitation, such as food sensitivities and food allergies.

Advantageously, the cheese flavoring replacement system detailed in Table 2 as a component of another food product (e.g., a meat-or seafood-based, or imitation meat or sea food product, or other savory food product) comprises generally between about 1 to about 35 percent or more of the total weight of the product, depending on the moisture content of the flavoring replacement system and that of the consumable food product.

The cheese flavoring replacement system may comprise, as a percent by weight of any consumable food product to which it is added, and depending on the type of food product and whether water or other liquid is included as part of the food product, is present in an amount between about 1 and about 35 percent, between about 1 to 2 percent, between about 2 to about 4 percent, between about 1 to about 30 percent, between about 3 to about 5 percent, between about 5 to about 7 percent, between about 6 to about 8 percent, between about 7 to about 10 percent, between about 10 percent and about 12 percent, between about 12 percent and about 14 percent, between about 14 percent and about 18 percent, between about 18 percent and about 22 percent, between about 22 percent and about 28 percent, and between about 28 percent and about 35 percent of the total weight of the food product in which the replacement system is incorporated.

### Categories of Ingredients Among the Preferred, Essential Categories of Ingredients in the Cheese Flavoring Replacement System

In an embodiment, preferred, essential ingredient categories and ingredients listed in Table 2 were identified by the machine learning system (referenced above) and exhibit the desired ayurvedic properties, functionalities, and cheese flavorings in preferred embodiments. In other embodiments, one or more plant-only, minimally processed and non-synthetic alternative ingredients imparting the same or similar flavors may also be used in place of one or more (or all of) the listed ingredients to impart the same or similar flavorings as those replaced Table 2 categories and ingredients. There are several categories of ingredients contributing a variety of flavors through a selection of fruits, vegetables.

A principal ingredient category in the cheese flavoring replacement system for food products in particular is one or more fruits high in glutamate and aspartate (also known as aspartic acid), two key cheese flavoring amino acids.

### The Synergistic Effect of the Composition:

The present disclosure deals with plant-only cheese flavoring replacement system which comprises of three ingredient sources i.e., (i) fruit source, (ii) vegetable source, (iii) spices and herb source.

In an exemplary aspect, Cheese flavor involves vast and complex compounds responsible for its cheesy flavor. Some compounds include amino acid metabolism. Some of the intense aroma-active compounds in the neutral basic fraction of the rosy/floral cheeses 2-phenethanol acetate (rosy), and included (rosy), phenylethyl phenylacetaldehyde (rosy/floral). The taste of the cheese is lactic acid, amino acids, 30 nonvolatile fatty acids, keto acids, nonvolatile amines, salt, and various fragments of the proteins and fats. The compounds that could contribute to the aroma portion of the flavor would include such groups as amines, fatty acids, aldehydes, ketones, alcohols, esters, and volatile sulphur compounds, such as hydrogen sulfide and mercaptans.

Cheese flavor containing plant substitutes:
Bell pepper
Blueberries
Apricots
Strawberries
Cherry tomatoes

Cheese flavors involve an earthy, nutty flavor contributed by alkylpyrazines, Earthy/bell pepper flavor commonly found in this cheese was associated with such as 2-isopropyl-3-methoxypyrazine and 2-isobutyl-3-methoxypyrazine. Certain varieties of bell peppers contain alkyl pyrazines such as 2-isobutyl-3-methoxypyrazine and 2-sec-butyl-3-methoxypyrazine, which are said to be responsible for the green earthy flavor. Next important flavor that comes to mind is its sour and fruity flavor. Alcohol, aldehydes and ketones like compound Methyl 3-methylbutanoate, Ethyl 3-methylbutanoate, Ethyl propanoate, hexanal and (Z)-3-hexenal. (E)-2-Hexen-1-ol (rancid-cheesy), (E)-2-hexenal (floral and sweet) in blueberries gives out cheesy, citrus, sulfury and a fruity flavor. Apricots contain esters that can impart floral and fruity flavor and aroma to the plant only cheese. When apricots are added in the formulation, it leads to a slight reduction in pH values during the storage period. This could be attributed to a limitation/prevention of growth and activity of resistant microflora, such as heat resistant proteinases or psychrotrophic bacteria present and enzymes in the product, which cause a hydrolysis of lactose to some acids that contributes to its characteristic taste.

Strawberries also contain esters (methyl and ethyl butanoate and methyl and ethyl hexanoate) which impart fruity and sour notes to the cheese.

Cherry tomatoes contain some volatile compounds like alcohols, aldehydes, esters and ketones which plays a role in imparting cheesy flavor. This cherry tomato also consists of organic sulfides which is of main interest for the formulation of plant only cheese. Any food product is said to be win-win only when its aroma and flavor goes together. These above-mentioned ingredients have bioactive composition, with a synergy to complement each other in enhancing flavor and aroma of cheese. Bioactive compounds in these ingredients when used together can undergo various chemical reactions which replicate the chemical reactions that take place in dairy based cheese formation.

Category 1: fruit source(s): cherry tomatoes, blueberries, strawberries and apricots are the preferred fruits of the disclosed cheese flavoring replacement system. Cherry tomatoes are certain small varieties of tomatoes.

Cherry tomatoes: Like certain cheeses, cherry tomatoes have a slightly tart and sour taste. In cheese, the caseins are metabolized to peptides and amino acids which form the metabolic precursors of volatile sulfur compounds, aldehydes, ketones and fatty acids, all of which contribute to a cheese flavor. Cherry tomatoes, with sulfur-containing compounds such as methional and dimethyl trisulfide, are responsible for a meaty and cheese-like flavor. Methional, hydrogen sulfide and dimethyl sulfide constitute the majority of sulfur-containing compounds in cherry tomatoes, and methional imparts flavor similar to cheddar cheese. In addition to these flavoring compounds, cherry tomatoes also contain organic acids such as malic, ascorbic, succinic and citric acids, contributing to the acidic flavor profile that is produced post-fermentation. These acids also aid in the preservation and shelf life of a food product containing them. The consumption of cherry tomatoes promotes the Ayurvedic properties of Rasa: (sweet), stringent; Virya: (heat); Vipaka: (sour).

Strawberries are one of the fruits in preferred embodiments of the cheese flavoring replacement system. Strawberries comprise a group of several varieties of fruits (Fragaria genus) that are a part of the rose family. A wild or cultivated, seasonal fruit in the north, they may be grown worldwide at various times of the year and are eaten raw, cooked and dried (and powdered). Strawberries contain about 0.1 gram of glutamate per 100 grams of fresh fruit. In cheese, one of the characteristic flavors is an aromatic fruity note that derives from a variety of compounds such as esters, which are produced as a result of enzymatic activity in cheese. The development of esters in cheese originates from milk cultures. Strawberries, too, contain esters such as methyl butanal, hexanoate, and methyl propanal (a colorless, liquid aldehyde), which impart a complex flavor of malt, apple, and more pungent profiles. Ethyl butyrate, one of the most important strawberry esters, contributes to a ripe fruit flavor, and is due to a complex mixture of both organic and inorganic components. Strawberries contain 2-methylbutanoate, linalool, methyl butanoate and ethyl butanoate, which also provide sweetness to the system. Finally, strawberries also contain decalactone, an aromatic compound that imparts a creamy, sweet dairy nuance to the replacement system.

Blueberries-Blueberries are a highly nutritious berry, wild or cultivated. Blueberries contain high amounts of anthocyanin, organic acid and fiber, which significantly affect sensory evaluation, pH value, texture profile analysis (TPA) and microstructure. The blueberry flavor compounds impart light cheese and fruit flavors, and have a delicate fragrance, linked to the presence of fructose, a monosaccharide, which leads to its popularity as a sweet fruit. When added to a food product at roughly ten percent of the total volume of the food product, a cheesy, sour flavor and essence develop, such as linalool and cis-3-hexeno. Apricots are fruits of the family Prunis, which also includes peaches, cherries, plums and nectarines. Apricots are a sweet, tart stone fruit, meaning they contain a stone pit at their center, and have soft, velvety flesh and peel. Ripe apricots are primarily eaten raw, but can also be cooked and grilled, and are often dried.

In some embodiments, the cherry tomatoes, strawberries, blueberries and/or apricots are dried and provided in the cheese flavoring replacement system as a ground powder. In other embodiments the fruit(s) may be mixed with water, plant-derived liquid or other non-animal-sourced liquid to form a liquid, gel or other alternative form of the system suitable for mixing, storing, freezing and/or drying. In other embodiments, the fruits are provided in liquid or gel form. In still other embodiments, one or more substitute fruits may be used in combination, or with (or substituted by) other ingredients known to a person of ordinary skill that would provide the same or similar flavorings (and perhaps characteristics and features (functionality and properties)) for this category in the system. Further detail on this category is found in Table 3.

In the disclosed embodiments the amount of fruits (one or more of blueberries, cherry tomatoes, strawberries and apricots, and/or one or more substitutes to have the same or similar flavors, and possibly also the same or similar properties and functionalities as these ingredients) as a percentage of the cheese flavoring replacement system weight ranges between about 1 to about 50 percent, between about 1 to about 5 percent, between about 5 to about 8 percent, between about 8 to about 10 percent, about 10 to about 15 percent, between about 15 to about 20 percent, between about 20 to about 25 percent, between about 10 and about 35 percent, between about 20 to about 30 percent, between about 20 to about 40 percent, between about 30 to about 40 percent, between about 25 to about 30 percent, between about 30 and about 35 percent, between about 35 to about 40 percent, between about 40 to about 45 percent, and between about 45 to about 50 percent of the total weight of the cheese flavoring replacement system.

### Synergy Due to Fruit Source

Blueberries: The blueberry flavor compounds impart light cheese and little fruity flavors. The compounds that are perceived give a smooth and delicate fragrance. This flavor has a strong relationship with fructose and pH, and hence the sugars like monosaccharide fructose in blueberry are the most impactful effector of overall liking, sweetness and flavor, and detractor from sourness. When blueberry is added around 10% of the additive volume, it is a cheesy sour flavor essence by compounds like linalool and cis-3-hexenol. Apricots: Esters are important flavor-active compounds in cheese and result from the activity of bacteria. Apricot can replace synthetic cheese flavors as it contains similar esters which are present in synthetic cheese flavors. The volatile esters like ethyl octanoate present in apricots provide a fruity note flavor to soft cheese. In terms of sensory perception of aroma, benzaldehyde, linalool, 4-terpinenol, α-terpineol and perhaps 2-phenylethanol are responsible for the floral and fruity part of the aroma perceived in apricots that are in close resemblance with cheese.

Strawberries: In cheese, one of the characteristic flavors is aromatic fruity notes that come from a variety of compounds like esters which are produced as a result of enzymatic activity in cheese. This development of esters contributing to the cheese flavor comes from cultures or endogenous compounds in the milk. Ethyl butyrate, one of the most important strawberry esters, contributes to the “ripe” fruit flavor. Strawberry flavor is due to a complex mixture of both organic and inorganic components. Apart from this, strawberries have compounds like 2-methylbutanoate and linalool that impart the characteristic strawberry fruity flavor. Other esters in strawberry that can give cheese-like flavors are methyl butanoate and ethyl butanoate providing both sweetness and hence can be a potential replacement for cheese flavors.

Cherry tomatoes: Like certain cheeses, cherry tomatoes have a slightly tart and sour taste. In cheese, the caseins are metabolized to peptides and amino acids which form the metabolic precursors of volatile sulfur compounds, aldehydes, ketones and fatty acids. All these compounds contribute to the cheese flavor. Methional, Hydrogen sulfide and dimethyl sulfide constituted the majority of sulfur compounds in cherry tomatoes. Methional is one of the volatile compounds in cherry tomatoes that gives flavor similar to cheddar cheese. In order to develop the taste on similar lines as cheese, cherry tomatoes can be a potential option.

Category 2: Vegetable source(s): bell peppers are a primary component of the disclosed cheese flavoring replacement system. In certain embodiment, bell peppers are dried and ground prior to incorporating into the replacement system. In other embodiments, along with other components of the replacement system, they are added directly to foods raw, cooked, dried or frozen. Roasting increases the compounds that enhance the cheese flavoring.

Bell peppers are a member of the chile pepper family, Solanaceae. Bell peppers can produce cheese-like flavors due to the presence of alkyl pyrazines that are found naturally in a variety of vegetables. These alkyl pyrazines are metabolized as by products by certain plants, such as bell peppers. In cheeses, earth/bell pepper (EBP) flavors are developed in the cheese rind and interiors of the block of cheese due to the presence of certain pyrazines, namely: alkyl methoxypyrazines, such as 2-isopropyl-3-methoxypyrazine and 2-isobutyl-3-methoxypyrazine, which contribute to the umami and spice flavor notes and rich, cheesy afternotes. Bell peppers, containing hexenal, and impart a cheesy, earthy flavor. Bell peppers have the Ayurvedic properties of: Rasa-katu, Guna-Lakhu, Ruksha, Theeshna, Vipika-Katu, Veerya-Ushna.

Each ingredient in this category may be interchanged with the others or may be used in combination, or with (or substituted by) other ingredients known to a person of ordinary skill that would provide the same flavorings, and possibly similar characteristics and features or properties for this category in the system. Further detail on this category is found in Table 3.

In the disclosed embodiments the amount of vegetables (bell pepper and/or one or more substitutes have the same or similar flavors) as a percentage of the cheese flavoring replacement system weight ranges between about 5 to about 50 percent, between about 5 to about 10 percent, between about 5 to about 15 percent, between about 7 to about 11 percent, between about 8 to about 12 percent, between about 9 to about 13 percent, between about 10 and about 14 percent, between about 10 to about 20 percent, between about 10 to about 35 percent, between about 12 to about 15 percent, between about 14 to about 17 percent, between about 15 to about 18 percent, between about 17 to about 20 percent, between about 20 to about 25 percent, between about 25 to about 30 percent, between about 20 to about 40 percent, between about 30 to about 40 percent, between about 30 to about 35 percent, between about 35 to about 40 percent, between about 40 to about 45 percent, and between about 45 to about 50 percent of the total weight of the cheese flavoring replacement system.

### Synergy Due to the Vegetable Source:

Bell pepper: Bell peppers can produce cheese-like flavors due to the presence of alkylpyrazines that are found naturally in a variety of vegetables. These alkylpyrazines are metabolized by certain plants like bell peppers, as by products. The threshold testing of these flavors are a reason to conclude that EBP or earth/bell pepper flavors are developed in the rind and interiors of cheddar cheese due to the presence of certain pyrazines namely-alkyl methoxypyrazines such as 2-isopropyl-3-methoxypyrazine and 2-isobutyl-3-methoxypyrazine. Hence, bell pepper due to the presence of the same compounds can be used as a cheese flavor replacement.

Category 3: spice and herb source(s): Spices are the dried parts of a plant other than the leaves that are used as a seasoning or flavoring in a food product but are not a main ingredient. Herbs are the dried or fresh leaves of a plant used primarily in the same way although in some sauces, salads and condiments, herbs are frequently a main ingredient. One or more spices and herbs may be included as part of the cheese flavoring replacement system in the disclosed embodiments. For example, any one or more (or all) of ginger, turmeric, black pepper and rosemary may constitute the spice and herb category of the replacement system. In other embodiments, one or more of these may be replaced with an alternative herb or spice, or with a combination of alternative herbs and/or spices. Such substitutes (alternatives) would be known to a person of ordinary skill to provide the same or similar flavors, as well as properties, characteristics and/or functionalities as do the listed ingredients of this category. Further detail on this category is found in Table 3.

Ginger root (Zingiberaceae officinale) is used as a spice, and in medicine, and is an important source of vitamins and minerals. Ginger root also contains glutamic acid, which contributes a rich, umami flavor, and a bioactive composition comprising α-pinene, myrcene, p-cymene, 2-heptanol, 2-nonanol, bornyl acetate, and others, contributing a pungent, which enhances the sensorial properties of food products. In some embodiments ginger root is provided in the cheese flavoring replacement system as a finely ground powder. In other embodiments it may be mixed with water, plant-derived liquid or other non-animal-sourced liquid to form a liquid, gel or other alternative form of the system suitable for mixing, storing, freezing and/or drying. Ginger root promotes the ayurvedic properties of Rasa: Katu (Pungent), Vipaka: Madhura (Sweet), Virya: Heat, Guna, and Laghu (Light).

Turmeric root is a Southeast Asian and Indian spice ground from the dried, as its name implies, from the roots of the turmeric plant, a member of the ginger family. Both fresh turmeric root and dried, ground turmeric powder are used in cooking in Asian and Middle Eastern dishes. Ground turmeric is a yellow-colored powder. Turmeric has an earthy, pungent aroma with a hint of mustard or horseradish. When added to dishes, it brings out the other flavors, and results in the replacement system having a yellow or golden color.

Black peppercorns are the mature, dried berries of the vine, Piper nigrum, which is native to India. The berries grow on spikes of 50-60 berries on each spike and are harvested as green berries; enzymes in the berries cause the skin of the berry to turn black during the drying process. Black peppercorns have the strongest flavor of all peppercorns. The active ingredient in pepper is piperine, an alkaloid responsible for the pungent flavor of the berry.

Rosemary, Rosmarinus officinalis, is a perennial evergreen shrub, often used ornamentally, but is also an aromatic herb, a member of the Lamiaceae family with thousands of species, including sage and mint. It is used in a variety of dishes, pairing well with mushrooms, onions, peas, potatoes, spinach and a variety of grains. Rosemary may be used fresh or dried and, if dried, is chopped or pulverized.

In the disclosed embodiments the dry weight amount of ingredient(s) sourced from spices and herbs and/or one or more substitutes that have the same or similar flavors, and possibly also the same or similar properties and functionalities as these ingredients as a percent of the cheese flavoring replacement system weight, ranges from between about 1 to about 30 percent, between about 1 percent to about 2 percent, between about 2 to about 3 percent, between about 3 and about 6 percent, between about 4 to about 7 percent, between about 5 to about 8 percent, between about 5 and about 25 percent, between about 6 to about 8 percent, between about 7 to about 9 percent, between about 8 to about 10 percent, between about 9 to about 11 percent, between about 10 to about 12 percent, between about 11 to about 13 percent, between about 12 to about 14 percent, between about 13 to about 15 percent, between about 15 to about 20 percent, between about 20 to about 25 percent, and between about 25 to about 30 percent of the total weight of the cheese flavoring replacement system.

The combinations of preferred, essential fruits, vegetables, spices and herbs result in a plant-only cheese flavoring replacement system that may be incorporated into, or used as a coating on, any variety of food products ranging from baked and fried foods, snacks, frozen foods, vegetables or meat-containing foods as well as plant-based and plant only food products. In some embodiments, the mixtures of the identified, preferred ingredients result in a robust and flavorful cheese flavoring and seasoning product, ideal for replacing artificial, synthetic or highly processed seasonings used in commercially available food products. An intensified cheese flavoring is achieved through various interactions of compounds within and among the ingredients of the identified categories. For example, the combination of blueberries, cherry tomatoes and strawberries imparts a cheesy flavor, or enhances the flavor of cheese(s) already in a food product. As with almonds, the nutty flavor imparted by blueberries is due to the presence of benzaldehyde. Blueberries also contain aliphatic compounds hexanal, nonanal and heptanal, the latter, which imparts fat flavor notes and texture, which is smooth, similar to that of cheese, and which give a well-rounded mouth feel to the food product.

2-methylbutanal and 3-methylbutanal compounds, paired, have a similar structure and aroma and provide the strongest synergistic effect for the flavoring, as well as a masking effect, the latter, which could be due to the structural and aromatic differences existing between them: the cyclic structure of benzaldehyde versus a branched chain structure in 2-methylpropanal. In addition, benzaldehyde imparts an almond-like aroma while 2-methylpropanal gives a pungent, varnish-like aroma. The combination of 2-methylbutanal, 2-methyl propanal, 2-methylpropanal, and 3-methyl butanal also may provide a synergistic effect, producing a desirable, combined aroma. We note that those binary mixtures such as the various combinations of flavors marry well when they have similar structures and aroma profiles. The thiol group of methional itself adds to the umami or meatiness flavor profile of the cheese flavoring replacement system. Accordingly, a mixture of all the above compounds eliminates the masking of one flavor over another, and results in a milky, malty, nutty, acidic, meaty, and sulfur-containing flavor profile for the cheese flavoring replacement system. The desired flavor profile for the system will depend on the type of consumable food product in which the replacement system is mixed, with maximum aroma or odor thresholds of the system met within the relative ranges specified above for each of the categories. Any missing ingredients could result in grassy, bitter flavor profile from the compounds mentioned above, once present above a certain concentration in the blend produce a different flavor profile in the food system.

The addition of the cheese flavoring system's ingredients as flavoring agents also may have a positive effect on textural properties of the food products in which the system is incorporated. The longer the ripening period of cherry tomatoes and strawberries in the system (which lower its pH), the greater the stiffness, gumminess, and chewiness of the food product(s) in which the system is incorporated. In the cheese-making process, a reduced pH causes ions covalently bound to casein (milk protein) strands to become protonated during curd formation, increasing hydrophobic interactions among protein molecules, and making the cheese curd harder and more elastic. The inclusion in the cheese flavoring replacement system of cherry tomatoes, which contain lycopene, also results in a yellow hue of the system.

The cheese flavoring of the system as a whole is maximized through contributions of the multiple ingredients to the mix. Alone or in various combinations as a cheese flavoring replacement system, the previously described ingredients are effective as natural flavoring agents, together, present in an amount of about 1 percent to up to 35 percent or more of the dry weight of a food product in/on which it is incorporated or coated, depending on the type of food product and the strength of flavor desired.

TABLE 3
Categories of ingredients among the preferred, essential categories
of ingredients in the Plant-only cheese flavoring replacement system

| | | Compounds | | |
|---|---|---|---|---|
| | | responsible | | |
| Category / | Functionality | for | Physicochemical | Ayurvedic |
| Ingredient | relating to flavor | functionality | properties | properties |
| Category 1: | Cherry | Methional, | TSS -6.1 | Rasa: sweet, |
| Fruit sources: | tomatoes: | 4- | PH - 4.2 | astringent |
| Cherry tomatoes, | The caseins are | Methylphenol | Total acidity -0.39 | Virya: Heat |
| strawberries, | metabolized to | Methional taste | Moisture -92% | Vipaka: Sour |
| blueberries, | peptides and | is similar to | wet basis | |
| apricots and/or | amino acids | that of cheddar | Bulk density: | |
| one or more | which form the | cheese | 464.5 kg/sq m | |
| substitutes with | metabolic | | Viscosity: 13.14 | |
| the same or | precursors of | | m/s | |
| similar flavors, | volatile sulfur | | | |
| properties and | compounds, | | | |
| functionalities as | aldehydes, | | | |
| the ingredients in | ketones and fatty | | | |
| this category | acids. All these | | | |
| | compounds | | | |
| | contribute to the | | | |
| | cheese flavor. | | | |
| | Methional, | | | |
| | Hydrogen sulfide | | | |
| | and dimethyl | | | |
| | sulfide constituted | | | |
| | the majority of | | | |
| | sulfur | | | |
| | compounds. | | | |
| | Methional is one | | | |
| | of the volatile | | | |
| | compounds in | | | |
| | cherry tomatoes. | | | |
| Strawberries | Major | Esters, ketones, | Moisture content: | Rasa: sweet, |
| (Cat. 1) | constituents | aldehydes and | 87 to 94% | astringent, |
| | contributing to the | lactones | pH: 3.0-3.5 | Amla (sour) |
| | flavors in | | Density: 0.59 | Guna: Laghu |
| | Strawberries | | g/cm3 | (light) |
| | contain these | | Sugar: 4.9 g/100 g | |
| | major constituents | | | |
| | that provide | | | |
| | flavor: esters, | | | |
| | (e.g. methyl | | | |
| | hexanoate, methyl | | | |
| | butanoate, MA), | | | |
| | monoterpenes | | | |
| | (e.g., linalool, | | | |
| | nerolidol), | | | |
| | ketones (e.g., 2- | | | |
| | pentanone, 2- | | | |
| | heptanone), | | | |
| | aldehydes (e.g., 2- | | | |
| | hexenal), lactones | | | |
| | and furanones | | | |
| | (e.g., γ- | | | |
| | decalactone, | | | |
| | mesifurane). | | | |
| Blueberries | Volatile flavor | Benzaldehyde, | Moisture: | Rasa |
| (Cat. 1) | compounds in | a flavor | 85.78 ± 0.62% | Katu (Pungent) |
| | blueberries | compound, ha | Lipids: | Guna |
| | enzymatically | an almond-like | 0.73 ± 0.06% | Laghu (light), |
| | produced by the | scent and | Carbohydrates as | Ruksha (dry), |
| | action of amino | imparts a | sugars: | Tikshna (sharp) |
| | acids, | creamy, cheesy | 70.65 ± 1.55% | Veerya |
| | carbohydrates, | and sweet | Protein: | Ushna (hot) |
| | etc. | flavor note. | 4.10 ± 0.08% | Vipaka |
| | | Aliphatic | pH: ~3 | Katu (pungent) |
| | | compounds: | Soluble Solids: | |
| | | hexanal, | (°Brix) | |
| | | heptanal and | 10.67 ± 0.29 | |
| | | nonanal. | | |
| Category 2: | Both dried and | Hexanal | pH: 4.8 to 5.2 | Rasa -katu |
| Vegetable | fresh bell pepper | | Moisture: 80% | Guna- Lakhu, |
| source(s): bell | contains hexanal, | | | Rukaha, |
| pepper and/or | some of which is | | | Theeshna |
| one or more | lost in the drying | | | Vipika- Katu |
| substitutes with | process. | | | Virya- Ushna |
| the same or | hexanal is one of | | | |
| similar flavors, | the compounds | | | |
| properties and | responsible for | | | |
| functionalities as | the characteristic | | | |
| the ingredients in | flavor of cheese | | | |
| this category | | | | |
| Category 3: | Ginger root | Aspartic acid, | Moisture content: | Rasa: Katu |
| spice and herb | belongs to the | glutamic acid, | 83%-94% (not | (pungent) |
| source(s): | family of | glycine, | dried) | Vipaka: |
| ginger root, | Zingiberaceae. | alanine, and | pH: 5.60-5.90 | Madhura |
| turmeric, black | Ginger imparts an | proline | Density: | (sweet); |
| pepper and | umami flavor | strongly | 435.6-410.78 | Virya: (heat) |
| rosemary and/or | along with its | affected the | g/l | Guna: Laghu |
| one or more | characteristic | umami taste | | (light) |
| substitutes with | spiciness, and | ginger root | | |
| the same or | refreshing aroma. | imparts. | | |
| similar flavors, | | | | |
| properties and | | | | |
| functionalities as | | | | |
| the ingredients in | | | | |
| this category | | | | |

TABLE 4
Typical ingredients and their amounts in a commercially
available cheese flavoring mix used in the food industry

| | Percent Weight of Typical |
|---|---|
| Typical Flavoring Mix Components | Cheese Flavoring Mix |
| Modified potato starch | 30 |
| Palm fruit oil | 10 |
| Cellulose | 4 |
| Maltodextrin | 2 |
| Vegetable glycerin/ sunflower lecithin | 2 |
| Sea salt | 1.5 |
| Citric acid, calcium phosphate | 20 |
| Nutritional yeast | 3 |
| Carrageenan | 1 |
| Natural flavorings | 25 |
| Rennet | 1.5 |

Table 4 provides an example of a commercially available cheese flavoring mix. The cheese flavoring replacement system of the disclosed embodiments can be used in whole or in part to replace the flavoring mix detailed in Table 4.

### Preparation of the Cheese Flavoring Replacement System or its Component Categories

In one embodiment, the cheese flavoring replacement system, or any of its individual categories, individual ingredients or combinations of ingredients within each category, can be prepared by combining and mixing the dried, powdered ingredients selected from Table 1 in the relative amounts identified as preferred, essential ingredients of the system to be used in one or more desired food products. In some embodiments the cheese flavoring replacement system may be in the form of a liquid, gel or cream due to the addition of water or other plant-derived liquid. In some embodiments the cheese flavoring replacement system is mixed with additional water or plant-derived liquid, then dried and powdered and stored. In some embodiments the cheese flavoring replacement system is prepared in extract or liquid form and freeze dried. In certain embodiments, the cheese flavoring replacement system may be prepared and stored as a liquid or moist form (as in a gel or dough). In certain other embodiments the cheese flavoring replacement system may be prepared as a liquid, gel, cream or in dried form and then frozen for storage. In other embodiments, each of the categories of ingredients, individual ingredients, or combinations of ingredients within each of the categories of the cheese flavoring replacement system, whether in liquid, gel, dried or other form, are mixed individually directly into and become a part of another food product rather than being combined as the complete replacement system prior to incorporation into another food product. The addition of a liquid to the replacement system will necessarily modify (increase) relative weight of the replacement system as a component of a food product.

In some embodiments the cheese flavoring replacement system stands alone as a plant-only food product that can be added to one or more ingredients or other food replacement systems to form any type of consumable food product requiring a cheese flavoring. In other embodiments the cheese flavoring replacement system is a component of another food product. In certain embodiments the cheese flavoring replacement system is a component of a baked or fried food product, a soup or sauce, a snack or a frozen food or other food product mix (such as a burger, patty or other shape, or mix), which may then be incorporated into other food products. In still other embodiments the food product is one of several components used to create the final food product. In some embodiments the food product is a stand-alone product. In other embodiments, the ingredients listed in Table 1 may be selected and combined in other relative amounts (a variety of ranges) identified for each of the categories to achieve the required functional and aesthetic features most closely resembling those of conventionally used, commercially available flavorings and additives. In other embodiments, the cheese flavoring replacement system may be used as an alternative, natural option to enhance the flavor of pet and other animal feeds.

The combination of categories and ingredients comprising a cheese flavoring replacement system for traditional ingredients and additives in commercially available animal- and plant-based products, as well as their physicochemical and Ayurvedic properties are shown in Table 3.

### Methods and Preparation of Plant Only Cheese Flavoring Replacement System in Food Products.

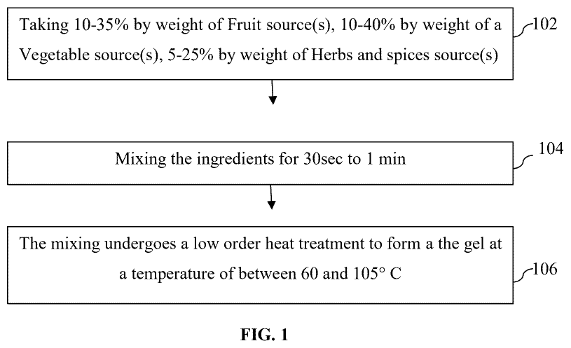

The method and preparation of plant only cheese flavoring replacement system in food products is illustrated in the FIG. 1.

The step 102 is the mixing the dried powder: Fruit source (10-35%), Vegetable source (10-40%), and Spices and herb plant source (5-25%).

The 104 says Mixing of ingredients was done for 30 sec to 1 min.

The 106 says the mixture undergoes a low order heat treatment to form a gel at a temperature of between 6° and 105° C.

In an embodiment, the plant only cheese flavoring replacement system requires any of its individual categories and blends of ingredients, can be prepared by combining 10 and mixing the dried, powdered ingredients selected from Table 2 in the relative amounts identified as preferred, essential ingredients of the system to be used in a desired food product.

In one embodiment, the plant only cheese flavoring replacement system comprises fruit sources. Yet another embodiment, preparing blueberries involves washing and drying is done using a food dehydrator. Grinding the dried blueberries is performed in a blender at 3000 rpm. Storing the powder takes place in a cool, dry place.

In one more embodiment, the plant only cheese flavoring replacement system comprises vegetable sources. Yet another embodiment, preparation of bell pepper involves washing and cutting the bell peppers into small pieces, they are then spread on a baking sheet. Drying the bell pepper pieces in the oven for 8-10 hours until they are completely dry and brittle. Grinding the dried bell peppers in a blender until they become a fine powder, this is then sieved and stored.

In one more embodiment, the plant only cheese flavoring replacement system comprises herbs and spices source. Yet another embodiment, preparation of ginger root involves peeling, washing, and cutting the ginger root into small pieces, they are then spread on a baking sheet. Drying the small pieces in the oven for 8-10 hours until they are completely dry and brittle. Grinding the dried ginger root pieces in a blender until they become a fine powder, this is then sieving and storing.

### Uses, Applications and Benefits of the Disclosed Embodiment

Plant only cheese flavoring replacement system in food product can be snacks like crackers, chips, and popcorn, dairy products such as cream cheese, sour cream, and yogurt to create cheese-based dips and spreads., baked goods like bread, muffins, and biscuits, meat analogues, salads and dressings like Alfredo sauce and Caesar dressing and beverages such as smoothies and protein shakes to create a savory, cheesy flavor profile.

Merely for illustration, only representative number/type of graph, chart, block, and sub-block diagrams were shown. Many environments often contain many more block and sub-block diagrams or systems and sub-systems, both in number and type, depending on the purpose for which the environment is designed.

While specific embodiments of the disclosed embodiments have been shown and described in detail to illustrate the inventive principles, it will be understood that the disclosed embodiments may be embodied otherwise without departing from such principles.

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment” and similar language throughout this specification may, but do not necessarily, all refer to the same embodiment.

It should be understood that the figures and/or screen shots illustrated in the attachments highlighting the functionality and advantages of the disclosed embodiments are presented for example purposes only. The disclosed embodiments are sufficiently flexible and configurable, such that it may be utilized in ways other than that shown in the accompanying figures.

It should be understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. A plant-only cheese flavoring replacement system for use in food products comprising:
a) 10-35% by weight of a fruit source, b) 10-40% by weight of a vegetable source, and c) 5-25% by weight of herbs and spices source.

2. The plant-only cheese flavoring replacement system as claimed in claim 1, wherein the fruit source is selected from blueberries, strawberries, apricots, cherry tomatoes, Pineapple, Tamarillo, Plum, Barbados cherry, Pomelo, Peach or combinations thereof.

3. The plant-only cheese flavoring replacement system as claimed in claim 1, wherein the vegetable source is selected from bell peppers, Cabbage, Onions, Garlic, Green beans, Broccoli, Cauliflower, Celery, Asparagus, sweet potates or combinations thereof.

4. The plant-only cheese flavoring replacement system as claimed in claim 1, wherein the herbs and spices source is selected from ginger root, turmeric root, black peppers, rosemary, Peppermint, coriander leaves, thyme, M. spicata, Angelica, Caper, Sweet Marjoram or combinations thereof.

5. The plant-only cheese flavoring replacement system as claimed in claim 1, wherein the food products comprise crackers, chips, popcorn, dairy products comprising cream cheese, sour cream, and yogurt to create cheese-based dips and spreads, baked goods comprising bread, muffins and biscuits, meat analogues, salads and dressings comprising Alfredo sauce and Caesar dressing, beverages comprising smoothies and protein shakes to create a savory, cheesy flavor profile.

6. A method for preparing a plant-only cheese flavoring replacement system for use in food products, wherein the method comprises:
Mixing a) 10-35% by weight of a fruit source, b) 20-40% by weight of a vegetable source, and c) 5-25% by weight of herbs and spices source at a temperature between 60 degrees Celsius and 105 degrees Celsius for about 30 seconds to one minute to form the plant-only cheese flavoring replacement system.

7. The method as claimed in claim 6, wherein the fruit source is selected from blueberries, strawberries, apricots, cherry tomatoes, Pineapple, Tamarillo, Plum, Barbados cherry, Pomelo, Peach or combinations thereof.

8. The method as claimed in claim 6, wherein the vegetable source is selected from bell peppers, Cabbage, Onions, Garlic, Green beans, Broccoli, Cauliflower, Celery, Asparagus, sweet potatoes or combinations thereof.

9. The method as claimed in claim 6, wherein the herbs and spices source is selected from ginger root, turmeric root, black peppers, rosemary, Peppermint, coriander leaves, thyme, M. spicata, Angelica, Caper, Sweet Marjoram or combinations thereof.

10. The method as claimed in claim 6, wherein the food products comprise crackers, chips, popcorn, dairy products comprising cream cheese, sour cream and yogurt to create cheese-based dips and spreads, baked goods comprising bread, muffins and biscuits, meat analogues, salads and dressings comprising Alfredo sauce and Caesar dressing, beverages comprising smoothies and protein shakes to create a savory, cheesy flavor profile.

11. The method as claimed in claim 6, wherein physical characterization data associated with ingredients of the plant-only cheese flavoring replacement system comprising the fruit source, the vegetable source, the herbs and spice source is stored in a database, wherein a machine learning model determines a unique combination of ingredients based on the physical characterization data to prepare the plant-only cheese flavoring replacement system.

12. The method as claimed in claim 11, wherein the physical characterization data of the ingredients comprise functional properties that comprise emulsification properties, stabilization properties, gelling properties, fat-replacement properties, Ayurvedic and/or other holistic properties, physicochemical properties that comprise pH, viscosity, moisture content, density, mechanical properties that comprise adhesive strength, tensile strength, shear resistance, chemical and/or molecular descriptor properties that comprise bio-active/bioavailability properties, molecular structure, phytonutrient properties, sensorial properties that comprise taste, smell, color, texture, mouth feel, and nutritional information that comprises macronutrient/micronutrient properties.
